(19) United States
(12) Patent Application Publication
(10) Pub. No.: US 2026/0285645 A1
(43) Pub. Date: Sep. 24, 2026

(54) CAR JIG AND METHOD FOR ASSEMBLING, TRANSPORTING, AND INSTALLING A CAR FOR AN ELEVATOR

(71) Applicant: INVENTIO AG, Hergiswil (CH)

(72) Inventors: Raphael Bitzi, Luzern (CH); Bjarne Lindberg, Hellbuhl (CH); Javier Varona, Clifton, NJ (US); Daniel Corcoran, Morristown, NJ (US)

(21) Appl. No.: 19/469,986

(22) PCT Filed: May 8, 2024
(86) PCT No.: PCT/EP2024/062743

§ 371 Date: Sep. 26, 2025

(30) Foreign Application Priority Data
May 25, 2023 (EP) 23175218.9

(51) Int. Cl. B66B 19/04

(52) U.S. Cl. CPC B66B 19/04

(57) ABSTRACT

A car jig for assembling, transporting, and installing a car for an elevator is described, comprising: a rectangular base frame having a top side, a bottom side, and four lateral sides surrounding a free inner space; a first and a second guide rail respectively arranged on a first and a second lateral side opposite to one another, each vertically extending from the base frame, wherein the first and second guide rails are arranged such that a position of and a distance between them correspond to a position of and, respectively, distance between corresponding guide rails within an elevator hoistway; a first carrier detachably arranged at the bottom side of the base frame such that the first carrier at least partly overlaps the free inner space; and a cross bar extending between and coupled to the first and the second guide rails at their ends facing away from the base frame.

The technology described herein generally relates to a car jig and a method for assembling, transporting, and/or installing a car for an elevator. More particularly, the technology relates to a car jig method for assembling, transporting, and/or installing a car for an elevator, to a method for installing the car in a hoistway of the elevator, and to a method for transporting the car of the elevator, wherein the car may be assembled within the car jig before transporting the car.

Elevators serve for transporting passengers with a car of the elevator throughout a hoistway within a building. Typically, a multiplicity of passengers and/or one or more goods may be accommodated within the car and may then be transported from a starting floor to a destination floor in the building. During such travel, further passengers may enter or exit the cabin during intermediate stops at other floors.

The car of the elevator may be pre-assembled in a respective factory. The pre-assembled car may be shipped to a respective construction site comprising at least a part of the hoistway of the respective building. For example, at least a ceiling of the hoistway may not be present yet such that the pre-assembled car may be introduced into the vertically open hoistway. For example, the hoistway may be formed by arranging two or more hoistway modules above each other, wherein only the lowermost hoistway module may have to be provided within the building such that the car may be introduced into the hoistway, in particular the lowermost hoistway module. The car may be transported to the construction site within a car jig. Alternatively, the car may be pre-assembled within the hoistway module and may be transported to the construction site within the corresponding hoistway module. Alternatively, the car may be assembled on the construction site within the hoistway, in case within the respective hoistway module.

U.S. Pat. No. 5,012,621 A describes a car jig for assembling, transporting, and installing a car for an elevator.

However, during the transport, the car may jump due to road holes vertically with respect to the car jig or, respectively, the hoistway module in which the car is arranged. Further, after removing the car from the car jig at the construction site and when installing the car within the hoistway, several workers may be necessary to introduce the car into the hoistway or, in case, the hoistway module.

Accordingly, there may be a need for an alternative approach for a car jig and/or a method for assembling, transporting, and/or installing the car within the hoistway, in particular the hoistway module at the construction site.

Such need may be met with the subject-matter of the independent claims. Advantageous embodiments are defined in the dependent claims as well as in the following specification and the associated figures.

According to a first aspect of the technology described herein, a car jig for assembling, transporting, and/or installing a car for an elevator is proposed. The car jig comprises a rectangular base frame having a top side, a bottom side, and four lateral sides surrounding a free inner space of the base frame; a first guide rail arranged on the top side on a first lateral side of the four lateral sides of the base frame such that the first guide rail extends from the base frame in vertical direction; a second guide rail arranged on the top side on a second lateral side of the four lateral sides of the base frame opposite to the first lateral side such that the second guide rail extends from the base frame in vertical direction, wherein the first guide rail and the second guide rail are arranged such that a position of and a distance between the guide rails of the car jig correspond to a position of and, respectively, distance between corresponding guide rails within an hoistway of the elevator; a first carrier detachably arranged at the base frame at the bottom side of the base frame such that the first carrier at least partly overlaps the free inner space of the base frame and a cross bar extending from the first guide rail to the second guide rail and being coupled to the first and second guide rails at ends of the first and second guide rails facing away from the base frame.

The cross bar may be referred to as cross head. The cross bar may comprise two profile bars each extending from the first guide rail to the second guide rail and being coupled to each other. Optionally, the cross bar may be arranged on the guide rails after arranging a lower platform of the car on the carrier and/or the base frame, and/or after arranging an upper yoke of the car at the guide rails.

According to a second aspect of the technology described herein, a method for installing the car of the elevator in the hoistway of the elevator is proposed. The method comprises arranging the car jig as described above and in the following and the car accommodated within the car jig on the hoistway; coupling the car to a crane; removing all carriers of the car jig from the base frame of the car jig; lowering the car into the hoistway by the crane; and removing the car jig from the hoistway.

According to a third aspect of the technology described herein, a method for transporting the car of the elevator proposed. The method comprises providing the car jig as described above and in the following; arranging the car within the car jig; clamping the car between the carrier and a cross bar of the car jig; and transporting the car jig with the car being clamped within the car jig.

In the present description, it is assumed that the car jig is oriented as intended for its use. That means that the base frame is arranged such that the top side is on top, the bottom side is on the bottom, and both are oriented horizontally. The guide rails extend vertically upward from the top side of the base frame and are oriented perpendicular to the top side. At the bottom side, one or more, e.g. four, foots may be arranged. The foots may be formed and arranged such that the base frame and optionally the carrier do not touch the ground when the car jig is arranged on a plane ground.

The car may comprise one or more guide elements for being guided by the guide rails. These guide elements may be held by the guide rails of the car jig as they may be held by the guide rails of the elevator within the hoistway later. When the car is lowered into the hoistway, the guide elements of the car may be carefully introduced from the guide rails of the car jig into the guide rails of the hoistway. So, the car may be guided by the guide rails of the car jig first, then by the guide rails of the car jig and of the hoistway, and at the end by the guide rails of the hoistway only.

The hoistway may be a conventional hoistway formed in a building, wherein the hoistway has to be open in vertical direction to be able to introduce the car into the hoistway. For example, a ceiling or ceiling module of the hoistway is not present when introducing the car into the hoistway. Alternatively, the hoistway may be formed by two or more hoistway modules, wherein the car may be introduced in one of these hoistway modules. For example, only a lower part, e.g. only a pit or pit module, of the hoistway may be present when introducing the car. In case of the hoistway being formed from two or more hoistway modules, only the lowermost hoistway module, e.g. the pit module, may have to be present, in order to introduce the car into the corresponding hoistway module. The rest of the hoistway, e.g. the ceiling or the remaining hoistway modules may be arranged on top of the already installed hoistway, after the car jig is removed.

For the present invention, it is not relevant whether the car jig is used for installing the car in the conventional hoistway or for installing the car in the hoistway module. Therefore, in the following, the terms “hoistway” and “hoistway module” are interchangeable and some of the features of the car jig and of the above methods may be explained with respect to the hoistway and some with respect to the hoistway module, but the features are not restricted to the one or the other.

When lifting up the car, e.g. to arrange it on the hoistway, the car may be directly coupled to the crane such that the car jig is lifted up when lifting the car by the crane. Alternatively, the car jig may be directly coupled to the crane and the car may be coupled to the crane via the car jig. Then, the car is lifted up when lifting up the car jig by the crane. When lowering the car into the open hoistway, the crane may be decoupled from the car jig and may be coupled to the car only. Alternatively, the car jig and the car may be directly coupled to the crane.

That the first guide rail and the second guide rail are arranged such that a position of and a distance between the guide rails of the car jig correspond to a position of and, respectively, distance between the corresponding guide rails within the hoistway of the elevator may correspond to that the first guide rail and the second guide rail are arranged such that the guide elements of the car may be coupled to and/or held by the first and, respectively, second guide rails. So, the position of and distance between the first and second guide rails may be defined by the position of and distance between the guide rails within the elevator shaft or by the car to be accommodated within the car jig, in particular by the position of and distance between the guide elements of the corresponding car. So, for different cars and/or different hoistways correspondingly different car jigs may be needed.

According to an embodiment, the cross bar comprises two profile bars each extending from the first guide rail to the second guide rail and a lifting pipe extending from one of the profile bars to another one of the profile bars. The car jig may comprise two or more of the lifting pipes. The lifting pipes may be used for coupling the profile bars to each other, for coupling the car to the car jig, and/or for lifting up the car jig, e.g. by the crane. For example, the car jig may be lifted up at the lifting pipes of the cross bar. For example, one or more ropes may be wrapped around the lifting pipes and the ropes may be lifted up by the crane, thereby lifting up the car jig. The profile bar may be arranged at a given distance to each other such that a free volume may be formed between the profile bars.

According to an embodiment, the car jig comprises a pre-tensioning member being mechanically coupled to the cross bar such that the pre-tensioning member can be moved relative to the cross bar towards the first carrier for clamping the car between the cross bar and the first carrier. The pre-tensioning member may enable to provide a pressure against the car towards the carrier such that the car is clamped between the cross bar and the carrier. The corresponding tension working on the car may contribute to that the car cannot jump within the car jig during a transport of the car jig with the car.

According to an embodiment, the pre-tensioning member is coupled to the cross bar by screws on a side of the cross bar facing away from the base frame such that the pre-tensioning member is moved relative to the cross bar towards the first carrier by screwing the screws into the cross bar. The screws enable to clamp the car between the cross bar and the carrier in an easy and controllable way, in particular with the help of the pre-tensioning member.

According to an embodiment, the pre-tensioning member comprises a bracket extending at least in part through the cross bar. For example, when the cross bar is formed by the profile bars arranged at the given distance such that the free volume is formed between the profile bars, a part of the bracket may extend at least partly through the free volume. Optionally, a coupling member such as e.g. a wooden board or plank, may be arranged between the bracket and the car such that the car is pressed towards the first carrier by the bracket via the coupling member. The named board or plank may also consist of rubber.

According to an embodiment, the car jig comprises a buffer arranged on the first carrier and extending in vertical direction within or at least towards the free inner space of the base frame, with the buffer at least partly being elastic in the vertical direction. The buffer as a whole may provide this elasticity, or only a part of the buffer provides this elasticity. For example, the buffer may be formed of or may comprise an elastic element providing this elasticity. For example, the elastic element may be made of or may comprise rubber, with the rubber having the above modulus of elasticity. When the pre-tensioning member is moved relative to the cross bar towards the first carrier for clamping the car between the cross bar and the first carrier, the car may be arranged on the buffer such that the pre-tensioning member presses the car against the buffer and that the car is clamped between the pre-tensioning member on the cross bar and the buffer on the first carrier. So, the car may be clamped between the cross bar and the first carrier by clamping the car between the cross bar and the buffer on the first carrier. The position of the car jig's buffer relative to the car may be the same as position of buffer located in the hoistway relative to the car.

According to an embodiment, the car jig as explained above and in the following may comprise a second carrier detachably arranged at the base frame at the bottom side of the base frame next to the first carrier such that the second carrier at least partly overlaps the free inner space of the base frame, wherein the first and second carrier are hollow and configured for being grasped by a fork of a forklift. That the carriers are configured for being grasped by a fork of a forklift, may mean that the carriers are formed and arranged such that the fork of the forklift may be introduced into the hollow carriers. For example, the hollow space within the carriers may extend from the first lateral side to the second lateral side and is open at least one of these sides such that the fork may be introduced into the hollow space. A distance of the carriers to each other may correspond to a distance of two buffers located in the hoistway.

The first and/or second carriers may be formed and arranged such that they span over the complete width of the free inner space surrounded by the base frame. So, as long as the carriers are coupled to the base frame, the car may not be moved through the free inner space surrounded by the base frame. However, the car may be moved through the free inner space surrounded by the base frame when the carriers are removed from the base frame, e.g. for lowering the car into the hoistway.

In case of arranging the second carrier, another buffer may be arranged on the second carrier. In this context, the buffer on the first carrier may be referred to as first buffer and the buffer on the second carrier may be referred to as second buffer.

According to an embodiment, the car jig as explained above and in the following may comprise at least one strut for each of the vertically arranged first and second guide rails, wherein the struts are configured for laterally supporting the corresponding guide rail and wherein the struts extend from the corresponding side of the base frame next to the corresponding guide rail to an upper portion of the corresponding guide rail. For example, two of the struts may be arranged for each of the first and second guide rails, e.g. one strut at each side of each of the first and second guide rails.

According to an embodiment, each of the guide rails comprises a base component and a guide component, wherein the base component is arranged at the top side of the base frame and wherein the guide component is coupled to an inner side of the corresponding base component such that the guide component extends all over the length of the base component and additionally through the free inner space of the base frame. So, each of the guide rails may be composed of two components, i.e. the base component and the guide component. The guide rails extend from the base frame upward in vertical direction. The guide rails being composed of the base component and the guide component enable that the guide rails at least in part, in particular the guide component, additionally extend from the base frame downward in vertical direction. This may contribute facilitating an installation of the car within the elevator shaft. For example, the guide components may extend so far that the guide components touch the guide rails of the hoistway, when the car jig is arranged on the open hoistway.

According to an embodiment, the method for installing the car of the elevator in the hoistway of the elevator comprises, before arranging the car jig with the car on the hoistway, providing the car jig as explained above and in the following; arranging the car within the car jig; clamping the car between a carrier and a cross bar of the car jig; and transporting the car jig with the car being clamped within the car jig.

According to an embodiment, the car may be arranged within the car jig by assembling the car within the car jig. For example, a lower yoke of the car may be arranged on the carrier(s), in particular on the buffer(s), and the lower platform of the car may be assembled on the lower yoke. Then, the upper yoke of the car may be coupled to the first and second guide rails. Afterwards, the cross bar may be arranged as described above over the upper yoke. Then, lateral side walls of the car may be assembled vertically between the upper yoke and the lower platform.

It shall be noted that possible features and advantages of embodiments of the technology described herein are described herein partly with respect to the car jig and partly with respect to one or more of the above methods. One skilled in the art will recognize that the features may be suitably transferred from one embodiment to another and features may be modified, adapted, combined and/or replaced, etc. in order to come to further embodiments of the technology described herein.

In the following, advantageous embodiments of the technology described herein will be described with reference to the enclosed drawing. However, neither the drawing nor the description shall be interpreted as limiting the technology described herein.

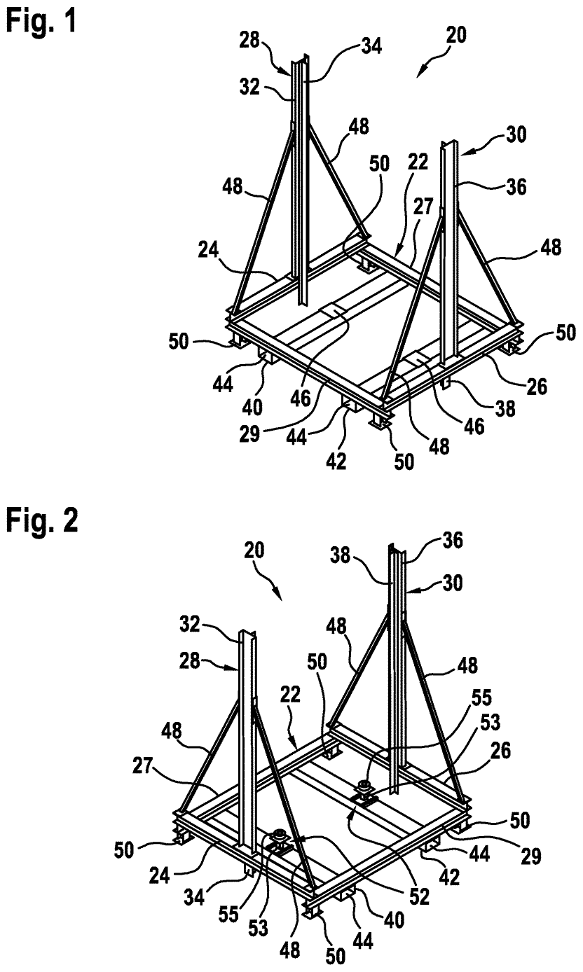

FIG. 1 shows a perspective view of a car jig in a first state according to an embodiment of the technology described herein.

FIG. 2 shows a perspective view of the car jig of FIG. 1 in a second state.

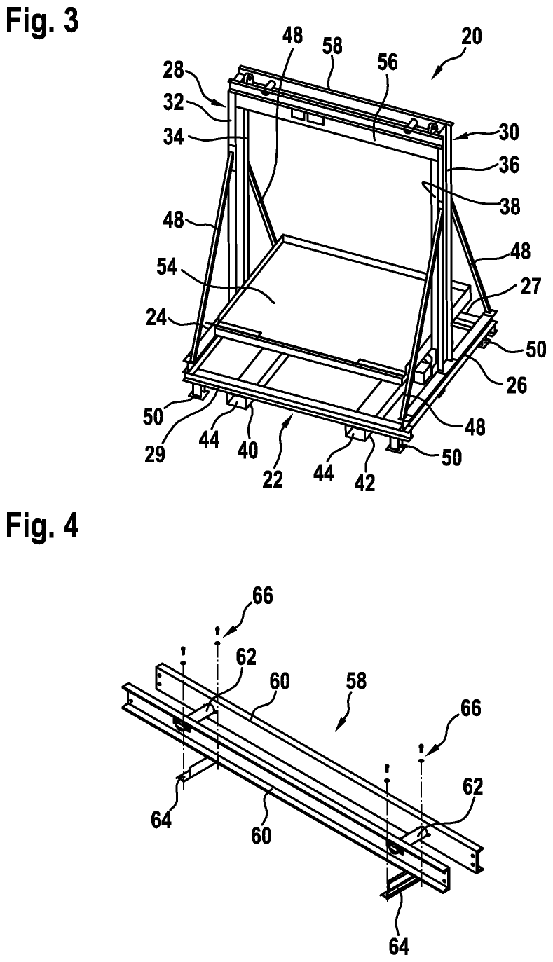

FIG. 3 shows a perspective view of the car jig of FIG. 1 in a third state.

FIG. 4 shows a perspective view of a cross bar of the car jig of FIG. 3.

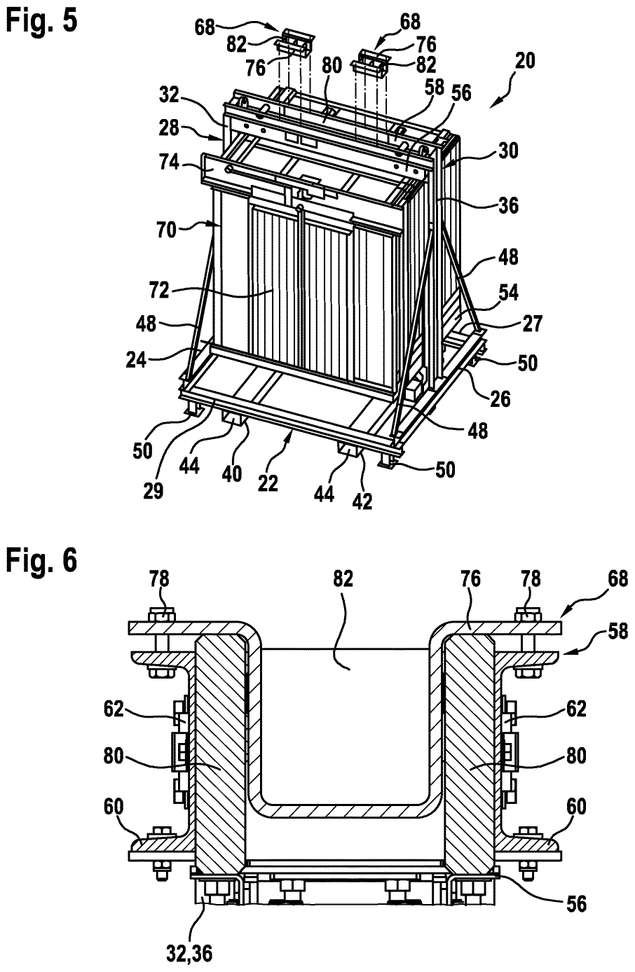

FIG. 5 shows a perspective view of the car jig of FIG. 3 and of a car accommodated within the car jig.

FIG. 6 shows a cross-sectional side view of the cross bar of FIG. 4 and of a pre-tensioning member according to an embodiment of the technology described herein.

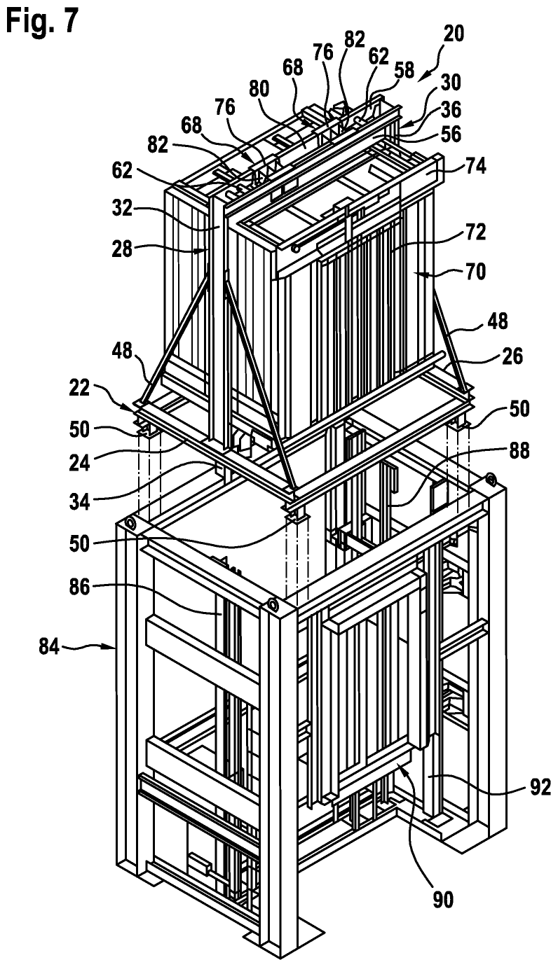

FIG. 7 shows a perspective view of the car jig and of the car accommodated within the car jig of FIG. 5 above a hoistway module in a first state.

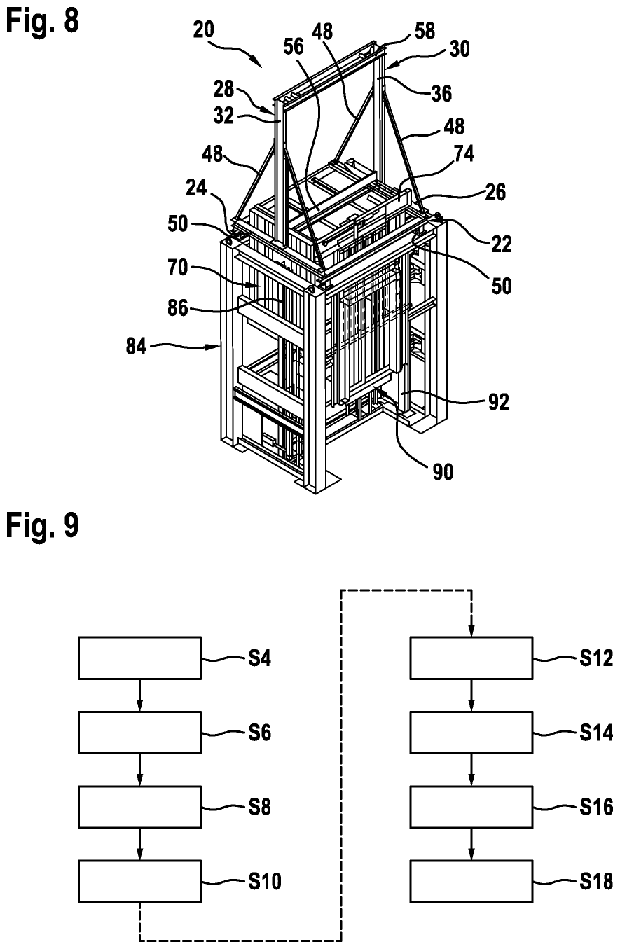

FIG. 8 shows a perspective view of the car jig and of the car accommodated within the car jig, and of the hoistway module according to FIG. 7 in a second state.

FIG. 9 shows a flow-chart of a method for transporting the car of an elevator and of a method for installing the car of the elevator in the hoistway of the elevator, according to an embodiment of the technology described herein.

The figures are only schematic and not to scale. Same reference signs refer to same or similar features.

FIG. 1 shows a perspective view of a car jig 20 in a first state according to an embodiment of the technology described herein. The car jig 20 may be configured for assembling, transporting, and/or installing a car 70 for an elevator (see FIGS. 5, 7, and 8). The car jig 20 comprises a rectangular base frame 22, a first guide rail 28, a second guide rail 30 and at least one carrier, e.g. a first carrier 40 and a second carrier 42.

The rectangular base frame 22 has a top side, a bottom side, and four lateral sides surrounding a free inner space of the base frame 22. A first lateral side 24 of the base frame 22 is parallel to a second lateral side 26 of the base frame 22. A third lateral side 27 of the base frame 22 is parallel to a fourth lateral side 29 of the base frame 22. The third and fourth lateral sides 27, 29 each extend from the first lateral side 24 to the second lateral side 26. The first guide rail 28 is arranged on the top side on the first lateral side 24 of the four lateral sides of the base frame 22 such that the first guide rail 28 extends from the base frame 22 in vertical direction. The second guide rail 30 is arranged on the top side on the second lateral side 26 of the four lateral sides of the base frame 22 opposite to the first lateral side 24 such that the second guide rail 30 extends from the base frame 22 in vertical direction.

In the present description, it is assumed that the car jig 20 is oriented as intended for its use, as shown in the figures. That means that the base frame 22 is arranged such that the top side is on top, the bottom side is on the bottom, and both are oriented horizontally. The first and second guide rails 28, 30 extend vertically upward from the top side of the base frame 22 and are oriented perpendicular to the top side.

The first guide rail 28 and the second guide rail 30 are arranged such that a position of and a distance between the first and second guide rails 28, 30 of the car jig 20 correspond to a position of and, respectively, distance between corresponding guide rails, e.g. third and fourth guide rails 86, 88 (see FIGS. 7 and 8), within an hoistway of the elevator. That the first guide rail 28 and the second guide rail 30 are arranged such that a position of and a distance between the first and second guide rails 28, 30 of the car jig 20 correspond to a position of and, respectively, distance between the corresponding guide rails 86, 88 within the hoistway of the elevator may correspond to that the first guide rail 28 and the second guide 30 rail are arranged such that guide elements of the car 70 may be coupled to and/or held by the first and, respectively, second guide rails 28, 30. So, the position of and distance between the first and second guide rails 28, 30 may be defined by the position of and distance between the guide rails 86, 88 within the hoistway or by the car 70 to be accommodated within the car jig 20, in particular by the position of and distance between the guide elements of the corresponding car 70.

The first and second carriers 40, 42 are detachably arranged at the base frame 22 at the bottom side of the base frame 22 such that the carriers 40, 42 at least partly overlap the free inner space of the base frame 22. For example, the carriers 40, 42 span over the whole width of the base frame 22. For example, the carriers 40, 42 may span from the third lateral side 27 of the base frame 22 to the fourth lateral side 29 of the base frame 22. The first and second carriers 40, 42 may be hollow because of a hollow space 44 within each of the carriers 40, 42 and may be configured for being grasped by a fork of a forklift. That the carriers 40, 42 may be configured for being grasped by a fork of a forklift, may mean that the carriers 40, 42 are formed and arranged such that the fork of the forklift may be introduced into the hollow carriers 40, 42, in particular into the hollow spaces 44 of the carriers 40, 42. For example, the hollow space 44 within the carriers 40, 42 may extend from the first lateral side 24 to the second lateral side 26 and may be open at least one of these sides 24, 26 such that the fork may be introduced into the hollow spaces 44.

Optionally, the car jig 20 may comprise at least one strut 48 for each of the vertically arranged first and second guide rails 28. 30, wherein the struts 48 are configured for laterally supporting the corresponding guide rail 28, 30 and wherein the struts 48 extend from the corresponding side of the base frame 22 next to the corresponding guide rail 28, 30 to an upper portion of the corresponding guide rail 28, 30. For example, two of the struts 48 may be arranged for each of the first and second guide rails 28, 30, e.g. one strut 48 at each side of each of the first and second guide rails 28, 30.

Optionally, each of the first and second guide rails 28, 30 may comprise a base component and a guide component. For example, the first guide rail 28 may comprise a first base component 32 and a first guide component 34, and the second guide rail 30 may comprise a second base component 36 and a second guide component 38. The base components 32, 36 may be arranged at the top side of the base frame 22. The guide components 34, 38 may be coupled to an inner side of the corresponding base component 32, 36 such that the guide components 34, 38 extend all over the length of the corresponding base component 32, 36 and additionally through the free inner space of the base frame 22.

The car jig 20 may comprise one or more foots 50, e.g. four foots 50. For example, the foots may be arranged at corners of the base frame 22. The foots 50 may be arranged at the bottom side of the base frame 22. The foots 50 may be configured for being arranged on a ground such that the carriers 40, 42 and/or the base frame 22 do not touch the ground when the car jig 20 is arranged on the ground.

In the first state, there are no buffers 52 (see FIG. 2) arranged on the carriers 40, 42 and no cross bar 58 (see FIG. 3) is arranged at the first and second guide rails 28, 30. However, in case the buffers 52 have to be provided, one buffer plate 46 may be arranged on each of the carriers 40, 42, wherein the buffer plate 46 may provide a support for the buffers 52.

FIG. 2 shows a perspective view of the car jig 20 of FIG. 1 in a second state. In the second state, the car jig 20 may comprise one or more buffers 52 arranged on the first carrier 40 and extending in vertical direction within or at least towards the free inner space of the base frame 22. In addition, the car jig 20 may comprise one or more further buffers 52 arranged on the second carrier 42 and extending in vertical direction within or at least towards the free inner space of the base frame 22. In this context, the buffer 52 on the first carrier 40 may be referred to as first buffer and the buffer 52 on the second carrier 42 may be referred to as second buffer.

The buffers 52 may be at least partly elastic in the vertical direction. Optionally, each of the buffers 52 as a whole may provide this elasticity, or only a part of the buffers 52 provides this elasticity. For example, the buffers 52 may be formed of or may comprise a flexible body, in other words an elastic element 55, providing this elasticity. For example, the elastic element 55 may be made of or may comprise rubber, with the rubber having the above modulus of elasticity. For example, the buffers 52 each may comprise a vertical post 53 on which the elastic element 55 is arranged. So, the vertical posts 53 may be arranged between the corresponding elastic element 55 and the corresponding carrier 40, 42.

FIG. 3 shows a perspective view of the car jig 20 of FIG. 1 in a third state. In the third state, a cross bar 58 may be arranged. The cross bar 58 may extend from the first guide rail 28 to the second guide rail 30. The cross bar 58 may be coupled to the first and second guide rails 28, 30 at ends of the first and second guide rails 28, 30 facing away from the base frame 22. The cross bar 58 may be referred to as cross head or tie beam. Optionally, the cross bar 58 may be arranged on the guide rails 28, 30 after arranging a lower yoke (not shown) and a lower platform 54 of the car 70 on the carriers 40, 42 and/or the base frame 22, and/or after arranging an upper yoke 56 of the car 70 at the guide rails 28, 30.

FIG. 4 shows a perspective view of a cross bar 58 of the car jig 20 of FIG. 3. The cross bar 58 may comprise two profile bars 60 each extending from the first guide rail 28 to the second guide rail 30 and being coupled to each other. The profile bars 60 may be arranged at a given distance to each other such that a free volume may be formed between the profile bars 60. The profile bars 60 may be mechanically coupled to each other by one, two or more connectors 64. Each of the connectors 64 may be mechanically coupled to both profile bars 60, e.g. by any suitable coupling means known in the art.

The car jig 20 may comprise two or more lifting pipes 62. The lifting pipes 62 may be arranged at the cross bar 58. The lifting pipes 62 may extend from one of the profile bars 60 to the other one of the profile bars 60. The lifting pipes 62 may be used for coupling the profile bars 60 to each other, for coupling the car 70 to the car jig 20, and/or for transporting the car jig 20. For example, the car jig 20 may be lifted up at the lifting pipes 62 of the cross bar 58. For example, one or more ropes (not shown) may be wrapped around the lifting pipes 62 and the ropes may be lifted up by a crane (not shown), thereby lifting up the car jig 20.

FIG. 5 shows a perspective view of the car jig 20 of FIG. 3 and of the car 70 accommodated within the car jig 20. The car 70 may comprise a car door 72. The car door 72 may be opened or closed by an opening mechanism 74. The car 70 may comprise one or more guide elements (not shown) for being guided by the guide rails 28, 30, 86, 88. These guide elements may be held by the first and second guide rails 28, 30 of the car jig 20 as they may be held by the guide rails 86, 88 of the elevator within the hoistway later.

The car jig 20 may comprise a pre-tensioning member 68, e.g. two pre-tensioning members 68 being mechanically coupled to the cross bar 58 such that the pre-tensioning members 68 can be moved relative to the cross bar 58 towards the carriers 40, 42 for clamping the car 70 between the cross bar 58 and the carriers 40, 42, in particular the buffers 52 on the carriers 40, 42. The pre-tensioning members 68 each may be moved relative to the cross bar 58 towards the car 70 to provide a pressure against the car 20 towards the carriers 40, 42, in particular towards the buffers 52 on the carriers 40, 42, such that the car 70 is clamped between the cross bar 58 and the carriers 40, 42, in particular the buffers 52 on the carriers 40, 42.

In other words, when the pre-tensioning members 68 are moved relative to the cross bar 58 towards the carriers 40, 42 for clamping the car 70 between the cross bar 58 and the carriers 40, 42, the car 70 may be arranged on the buffers 52 such that the pre-tensioning members 68 press the car 70 against the buffers 52 and that the car 70 is clamped between the pre-tensioning members 68 on the cross bar 58 and the buffers 52 on the carriers 40, 42. So, the car 70 may be clamped between the cross bar 58 and the carriers 40, 42 by clamping the car 70 between the cross bar 58 and the buffers 52 on the carriers 40, 42.

FIG. 6 shows a cross-sectional side view of the cross bar 58 of FIG. 4 and of one of the pre-tensioning members 68 according to an embodiment of the technology described herein. The pre-tensioning member 68 may be coupled to the cross bar 58 by screws 78 on a side of the cross bar 58 facing away from the base frame 22 such that the pre-tensioning member 68 is moved relative to the cross bar 58 towards the carriers 40, 42 by screwing the screws 78 into the cross bar 58.

The pre-tensioning member 68 may comprise a bracket 76 extending at least in part through the cross bar 58. For example, when the cross bar 58 is formed by the profile bars 60 arranged at the given distance such that the free volume is formed between the profile bars 60, a part of the bracket 76 may extend at least partly through the free volume. Optionally, one or more coupling members, such as a timber block 80, e.g. a wooden board or plank, may be arranged between the bracket 76 and the car 70, e.g. the upper yoke 56 of the car 70, such that the car 70 may be pressed towards the carriers 40, 42 by the bracket 76 via the coupling member. Optionally, each of the brackets 76 may be supported by one or more, e.g. three, plates 82 extending from one side of the brackets 76 to another side of the corresponding brackets 76.

FIG. 7 shows a perspective view of the car jig 20 and of the car 70 accommodated within the car jig 20 of FIG. 5 above a hoistway module 84 in a first state. In the first state, the car 70 is completely arranged within the car jig 20 and above the hoistway module 84. Instead of the hoistway module 84, the car jig 20 with the car 70 may be arranged on any open hoistway being formed by further hoistway modules or not. The car jig 20 may be configured such that the foots 50 at the bottom side of the base frame 22 can be arranged on and optionally fixed to upper lateral sides of the hoistway module 84. The car jig 20 with the car 70 may be arranged on the hoistway, in particular the hoistway module 84, in order to install the car 70 within the hoistway, in particular the hoistway module 84, as explained below with respect to FIG. 9. For example, positions for the foots 50 may be marked on the hoistway module 84 such that the car jig 20 and the car 70 are properly positioned with respect to the hoistway module 84 when the foots 50 are arranged at the corresponding marks. For example, the foots 50 and the upper lateral sides of the hoistway module 84 each may comprise drilling holes corresponding to each other such that when fixation means, e.g. screws, can be arranged within the drilling holes of the foots 50 and of the hoistway module 84 the car jig 20 and the car 70 are properly positioned with respect to the hoistway module 84.

The hoistway module 84 may comprise a hoistway door 90 and at least in part guide rails of the hoistway, e.g. a third guide rail 86 and a fourth guide rail 88. Optionally, a counterweight 92 of the elevator may be arranged within the hoistway module 84.

The guide elements of the car 70 may be coupled to and/or held by the third and fourth guide rails 86, 88, after the car 70 is installed within the hoistway module 84. Therefore, the car jig 20 may be arranged on the hoistway module 84 such that the first and second guide rails 28, 30 may flush with the third and, respectively, fourth guide rails 86, 88.

FIG. 8 shows a perspective view of the car jig 20 and of the car 70 accommodated within the car jig 20, and of the hoistway module 84 according to FIG. 7 in a second state. In the second state, the car 70 is already partly lowered into the hoistway, in particular the hoistway module 84, as explained below with respect to FIG. 9.

FIG. 9 shows a flow-chart of a method for transporting the car of an elevator and of a method for installing the car of the elevator in the hoistway of the elevator, according to an embodiment of the technology described herein. In particular, steps S4 to S10 represent a method for transporting the car 70 of the elevator, and steps S12 to S18 represent a method for installing the car 70 of the elevator in the hoistway of the elevator, in particular within the hoistway module 84. Both methods may be carried out after each other or the methods may be carried out independently, wherein carrying out one of the method does not imply that the other method is carried out also.

In step S4, the car jig 20 may be provided, e.g. formed and/or assembled, as described above.

In step S6, the car 70 may be arranged within the car jig 20. The car 70 may be arranged within the car jig 20 by assembling the car 70 within the car jig 20. For example, the lower yoke of the car 70 may be arranged on the carrier(s) 40, 42, in particular on the buffer(s) 52, and the lower platform 54 of the car 70 may be assembled on the lower yoke. Then, the upper yoke 56 of the car 70 may be coupled to the first and second guide rails 28, 30. Afterwards, the cross bar 58 may be arranged as described above over the upper yoke 56. Then, lateral side walls of the car 70 may be assembled vertically between the upper yoke 56 and the lower platform 54.

In step S8, the car 70 may be clamped between the carriers 40, 42 and the cross bar 58 of the car jig 20.

In step S10, the car jig 20 with the car 70 being clamped within the car jig 20 is transported, e.g. from a factory to a construction site.

In step S12, the car jig 20 as described above and the car 70 accommodated within the car jig 20 is arranged on the hoistway, in particular the hoistway module 84, e.g. as shown in FIG. 7. For arranging the car jig 20 with the car 70 on the hoistway module 84, the car 70 may be coupled to a crane directly or indirectly via the car jig 20. For example, the car 70 may be directly coupled to a crane such that the car jig 20 is lifted up when lifting up the car 70 by the crane. Alternatively, the car 70 may be coupled to the crane via the car jig 20. Then, the car 70 may be lifted up when lifting up the car jig 20 by the crane.

In step S14, all carriers 40, 42 of the car jig 20 may be removed from the base frame 22 of the car jig 20. Without the carriers 40, 42, the car 70 may be lowered into the hoistway, in particular the hoistway module 84, through the free space surrounded by the base frame 22.

In step S16, the car 70 may be lowered into the hoistway, in particular the hoistway module 84, by the crane. For lowering the car 70 relative to the car jig 20, the crane may be directly coupled to the car 20. For example, the crane may be decoupled from the car jig 20 for lowering the car 70 relative to the car jig 20. When the car 70 is lowered into the hoistway, in particular the hoistway module 84, the guide elements of the car 70 may be carefully introduced into the third and fourth guide rails 86, 88 of the hoistway module 84. So, during this process, the car 70 may be guided by the first and second guide rails 28, 30 of the car jig 20 first, then by the first to fourth guide rails 28, 30, 86, 88 of the car jig 20 and the hoistway module 84, and at the end by the third and fourth guide rails 86, 88 of the hoistway module 84 only.

The hoistway or, in case, the hoistway module 84 have to be open to be able to introduce the car 70 into the corresponding hoistway. For example, a ceiling or, in case, a ceiling module of the hoistway may not be present when introducing the car 70 into the hoistway. For example, only a lower part, e.g. only a pit or pit module, of the hoistway may be present when introducing the car 70. In case of the hoistway being formed from two or more of the hoistway modules 84, only the lowermost hoistway module 84, e.g. the pit module, may have to be present, in order to introduce the car 70 into the corresponding hoistway module 84. The rest of the hoistway, e.g. the ceiling or the remaining hoistway modules may be arranged on top of the already installed hoistway, after the car jig 70 is removed.

In step S18, the car jig 20 is removed from the hoistway, in particular the hoistway module 84.

The invention is not restricted to the embodiments explained above. In particular, the car jig 20 may comprise more or less than two carriers 40, 42 and/or more or less of the corresponding buffers 50. The buffers 50 may be made of a piece instead of two or more pieces. One or more of the struts 48 may be omitted. The first and second guide rails 28, 30 may be made of a piece instead of two or more pieces. The car jig 20 may be used for installing the car 70 in any open hoistway or hoistway module 84. The car jig 20 may comprise the pre-tensioning members 68 or not, or may comprise only one or more than two of the pre-tensioning members 68. The pre-tensioning members 68 may be used with or without the timber blocks 80.

Finally, it should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

1. A car jig for assembling, transporting, and installing a car for an elevator, the car jig comprising:
a rectangular base frame-having a top side, a bottom side, and four lateral sides surrounding a free inner space of the base frame;
a first guide rail arranged on the top side on a first lateral side of the four lateral sides of the base frame such that the first guide rail extends from the base frame in vertical direction;
a second guide rail arranged on the top side on a second lateral side of the four lateral sides of the base frame opposite to the first lateral side such that the second guide rail extends from the base frame in vertical direction, wherein the first guide rail and the second guide rail are arranged such that a position of and a distance between the guide rails of the car jig correspond to a position of and, respectively, distance between corresponding guide rails within an hoistway of the elevator;
a first carrier detachably arranged at the base frame at the bottom side of the base frame such that the first carrier at least partly overlaps the free inner space of the base frame; and
a cross bar extending from the first guide rail to the second guide rail and being coupled to the first guide rail and the second guide rail at ends of the first guide rail and the second guide rail facing away from the base frame.

2. The car jig of claim 1, wherein the cross bar comprises two profile bars each extending from the first guide rail to the second guide rail and a lifting pipe extending from one of the profile bars to another one of the profile bars.

3. The car jig of claim 1, further comprising a pre-tensioning member being mechanically coupled to the cross bar such that the pre-tensioning member can be moved relative to the cross bar towards the first carrier for clamping the car between the cross bar and the first carrier.

4. The car jig of claim 3, wherein the pre-tensioning member is coupled to the cross bar by screws on a side of the cross bar facing away from the base frame such that the pre-tensioning member is moved relative to the cross bar towards the first carrier-by screwing the screws into the cross bar.

5. The car jig of claim 3, wherein the pre-tensioning member comprises a bracket extending at least in part through the cross bar.

6. The car jig of claim 1, further comprising a buffer arranged on the first carrier and extending in vertical direction within or at least towards the free inner space of the base frame, wherein the buffer is at least partly elastic in the vertical direction.

7. The car jig of claim 1, further comprising: a second carrier detachably arranged at the base frame at the bottom side of the base frame next to the first carrier such that the second carrier at least partly overlaps the free inner space of the base frame, wherein the first carrier and the second carrier are hollow and configured for being grasped by a fork of a forklift.

8. The car jig of claim 1, further comprising: at least one strut for each of the vertically arranged first guide rail and second guide rail, wherein the struts are configured to laterally support the corresponding guide rail, and wherein the struts extend from the corresponding side of the base frame next to the corresponding guide rail to an upper portion of the corresponding guide rail.

9. The car jig of claim 1, wherein each of the guide rails comprises a base component and a guide component, wherein the base component is arranged at the top side of the base frame and wherein the guide component is coupled to an inner side of the corresponding base component such that the guide component extends over the length of the base component and additionally through the free inner space of the base frame.

10. A method for installing a car of an elevator in a hoistway of the elevator, the method comprising:
arranging a car jig in accordance with claim 1 and a car accommodated within the car jig on the hoistway;
coupling the car to a crane;
removing all carriers of the car jig from a base frame of the car jig;
lowering the car into the hoistway by the crane; and
removing the car jig from the hoistway.

11. The method of claim 10, comprising, before arranging the car jig with the car on the hoistway:
providing the car jig in accordance with claim 1;
arranging the car within the car jig;
clamping the car between a carrier and a cross bar of the car jig; and
transporting the car jig with the car being clamped within the car jig.

12. The method of claim 11, wherein the car is arranged within the car jig by assembling the car within the car jig.

13. A method for transporting a car of an elevator, the method comprising:
providing the car jig in accordance with claim 1;
arranging the car within the car jig;
clamping the car between a carrier and a cross bar of the car jig; and
transporting the car jig with the car being clamped within the car jig.

14. The method of claim 13, wherein the car is arranged within the car jig by assembling the car within the car jig.
